(19) United States
(12) Patent Application Publication
(10) Pub. No.: US 2025/0095665 A1
(43) Pub. Date: Mar. 20, 2025

(54) SYSTEMS AND METHODS FOR REAL-TIME ACCENT LOCALIZATION

(71) Applicant: Sanas.ai Inc., Palo Alto, CA (US)

(72) Inventors: Ankita JHA, Bangalore (IN); Piotr DURA, Warsaw (PL); David BRAUDE, Edinburgh (GB); Lukas PFEIFENBERGER, Salzburgh (AT); Alvaro ESCUDERO, San Sebastian de los Reyes (ES); Shawn ZHANG, Palo Alto, CA (US); Maxim SEREBRYAKOV, Palo Alto, CA (US)

(21) Appl. No.: 18/964,790

(22) Filed: Dec. 2, 2024

Related U.S. Application Data
(60) Provisional application No. 63/678,264, filed on Aug. 1, 2024.

(51) Int. Cl. G10L 21/02; G10L 15/02; G10L 21/013

(52) U.S. Cl. CPC G10L 21/02; G10L 15/02; G10L 21/013; G10L 2021/0135

(57) ABSTRACT

The disclosed technology relates to methods, speech processing systems, and non-transitory computer readable media for real-time accent localization. In some examples, a geolocation of a first user device is determined, and accent features are extracted from first input speech, in response to first input audio data comprising the first input speech obtained from the first user device. Accent profiles identified based on the determined geolocation are compared to the extracted accent features to identify one of the accent profiles most closely matching the extracted accent features. Second input speech is modified to adjust an accent represented in the second input speech based on the identified one of the accent profiles. The second input speech with the adjusted accent is then provided to an audio interface of a second user device to improve communication bridging between users of the first and second user devices.

This application claims priority to U.S. Provisional Patent Application Ser. No. 63/678,264, filed Aug. 1, 2024, which is hereby incorporated herein by reference in its entirety.

### FIELD

This technology generally relates to audio analysis and, more particularly, to methods and systems for real-time accent localization.

### BACKGROUND

In today's globalized world, businesses frequently interact with customers from diverse linguistic and cultural backgrounds. One sector particularly impacted by this diversity is the call center industry, where effective communication is paramount. Call centers serve as the primary point of contact between companies and their customers, handling a wide range of inquiries, complaints, and support issues. However, accents can pose significant challenges in these interactions, leading to misunderstanding, frustration, and reduced customer satisfaction.

Accents vary widely even within the same language, influenced by regional, social, and cultural factors. When call center agents and customers have different accents, it can be difficult for both parties to understand each other clearly. This issue is compounded in multinational call centers, where agents and customers may be located in different parts of the world. Existing solutions, such as training agents to neutralize their accents or employing basic speech recognition technology, have proven insufficient in addressing the dynamic and real-time nature of these communication challenges.

Moreover, current technologies lack the capability to detect and adapt to accents in real-time, making it difficult to provide immediate and effective solutions during live interactions. As a result, call center agents may struggle to comprehend customer queries, and customers may find it challenging to understand the responses, leading to decreased efficiency and potential loss of business.

The need for a more sophisticated approach is evident. A system that can accurately detect accents, predict potential accent-related misunderstandings, and convert accents in real-time would greatly enhance communication clarity and effectiveness. Such a system would not only improve the customer experience but also increase the efficiency of call center operations by reducing the time and effort needed to resolve issues.

### BRIEF DESCRIPTION OF THE DRAWINGS

The disclosed technology is illustrated by way of example and not limitation in the accompanying figures, in which like references indicate similar elements:

FIG. 1 is a block diagram of an exemplary network environment that includes a speech processing system with an exemplary accent localization device;

FIG. 2 is a block diagram of an exemplary storage device of the accent localization device of FIG. 1;

FIG. 3 is a flow diagram of an exemplary method for real-time accent localization; and

FIG. 4 is a flowchart of an exemplary method for real-time accent localization.

### DETAILED DESCRIPTION

Examples described below may be used to provide a method, a device (e.g., non-transitory computer readable medium), an apparatus, and/or a system for real-time accent localization. Although the technology has been described with reference to specific examples, various modifications may be made to these examples without departing from the broader spirit and scope of the various embodiments of the technology described and illustrated by way of the examples herein. The disclosed technology includes a speech processing system 100 that aids speakers with accents in adopting accents associated with listeners' geolocations, thereby enhancing communication clarity and reducing accent-related barriers, among other advantages explained in detail below.

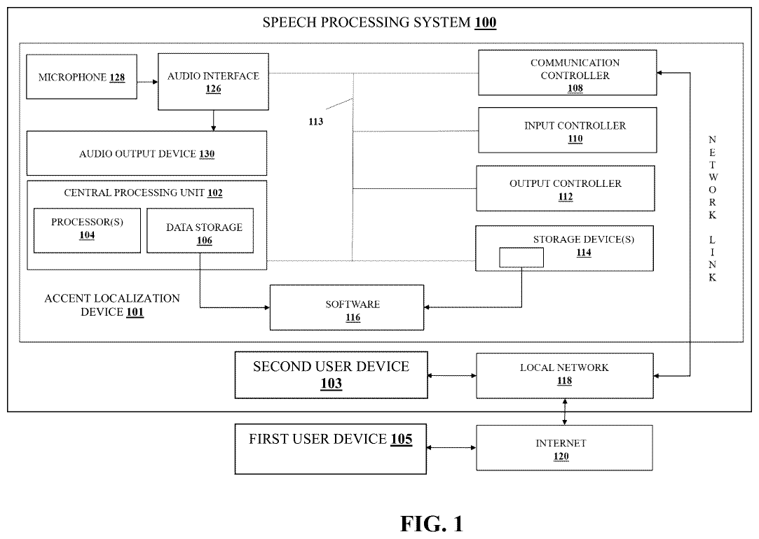

Referring now to FIG. 1, a block diagram of an exemplary network environment that includes a speech processing system 100 is illustrated. The speech processing system 100 in this example includes an accent localization device 101 and a second user device 103 coupled to the accent localization device 101 via a local network 118. The network environment also includes a first user device 105 coupled to the accent localization device 101 and the second user device 103 via the Internet 120 and the local network 118. The network environment may include other network devices such as one or more routers or switches, for example, which are known in the art and thus will not be described herein.

In this particular example, the accent localization device 101, first user device 105, and second user device 103 are disclosed in FIG. 1 as dedicated hardware devices. However, one or more of the accent localization device 101, first user device 105, and/or second user device 103 can also be implemented in software within one or more other devices in the network environment. As one example, the accent localization device 101, as well as any of its components or applications, can be implemented as software executing on the second user device 103, and many other permutations, types of implementations, and network topologies can also be used in other examples.

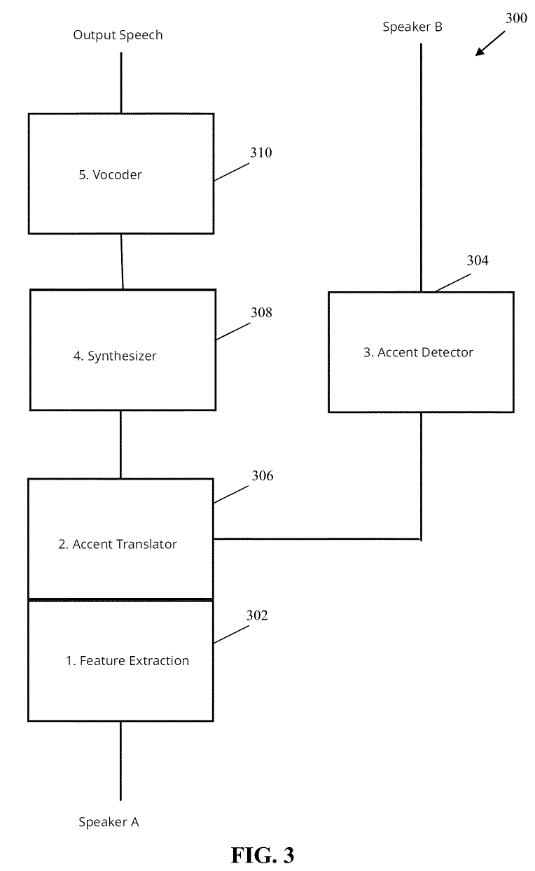

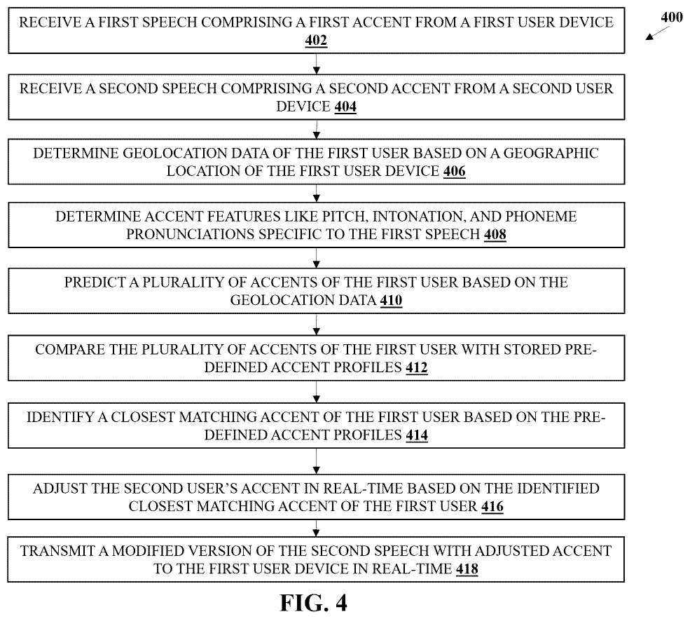

The accent localization device 101 in this example includes processor(s) 104, which are designed to process instructions (e.g., computer readable instructions (i.e., code)) stored on the storage device(s) 114 (e.g., a non-transitory computer readable medium) of the accent localization device 101. By processing the stored instructions, the processor(s) 104 may perform the steps and functions disclosed herein, such as with reference to FIG. 3-4, for example.

The accent localization device 101 also includes an operating system and microinstruction code in some examples, one or both of which can be hosted by the storage device(s) 114. The various processes and functions described herein may either be part of the microinstruction code and/or program code (or a combination thereof), which is executed via the operating system. The accent localization device 101 also may have data storage 106, which along with the processor(s) 104 form a central processing unit (CPU) 102, an input controller 110, an output controller 112, and/or a communication controller 108. A bus 113 may operatively couple components of the accent localization device 101, including processor(s) 104, data storage 106, storage device(s) 114, input controller 110, output controller 112, and/or any other devices (e.g., a network controller or a sound controller).

The output controller 112 may be operatively coupled (e.g., via a wired or wireless connection) to a display device (e.g., a monitor, television, mobile device screen, touch-display, etc.) in such a fashion that the output controller 112 can transform the display on the display device (e.g., n response to the execution of module(s)). Input controller 110 may be operatively coupled (e.g., via a wired or wireless connection) to an input device (e.g., mouse, keyboard, touchpad scroll-ball, touch-display, etc.) in such a fashion that input can be received from a user of the accent localization device 101.

The communication controller 108 in some examples provides a two-way coupling through a network link to the Internet 120 that is connected to a local network 118 and operated by an Internet service provider (ISP), which provides data communication services to the Internet 120. The network link typically provides data communication through one or more networks to other data devices. For example, the network link may provide a connection through local network 118 to a host computer and/or to data equipment operated by the ISP.

The audio interface 126, which is also referred to as a sound card, includes sound processing hardware and/or software, including a digital-to-analog converter (DAC) and an analog-to-digital converter (ADC). The audio interface 126 is coupled to a physical microphone 128 and an audio output device 130 (e.g., headphones or speaker(s)) in this example, although the audio interface 126 can be coupled to other types of audio devices in other examples. Thus, the audio interface 126 uses the ADC to digitize input analog audio signals from a sound source (e.g., the physical microphone 128) so that the digitized signals can be processed by the accent localization device 101, such as according to the methods described and illustrated herein. The DAC of the audio interface 126 can convert generated digital audio data into an analog format for output via the audio output device 130.

The accent localization device 101 is illustrated in FIG. 1 with all components as separate devices for ease of identification only. One or more of the components of the accent localization device 101 in other examples may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). The accent localization device 101 also may be one or more servers, for example a farm of networked or distributed servers, a clustered server environment, or a cloud.

While the accent localization device 101 is illustrated in this example as including a single device, the accent localization device 101 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices (e.g., the second user device 103). Additionally, one or more of the devices that together comprise the accent localization device 101 in other examples can be standalone devices or integrated with one or more other devices or apparatuses.

Each of the first user device 105 and the second user device 103 of the network environment in this example includes any type of computing device that can exchange network or other audio or speech data, such as mobile, desktop, laptop, or tablet computing devices, virtual machines (including cloud-based computers), or the like. Each of the first user device 105 and the second user device 103 in this example includes a processor, memory, and a communication interface, which are coupled together by a bus or other communication link (not illustrated), although other numbers or types of components could also be used.

Each of the first user device 105 and the second user device 103 may run services and/or interface applications that may provide an interface to communicate with each other and/or the accent localization device 101 via the local network 118 and/or the Internet 120 or other wide area network. Each of the first user device 105 and the second user device 103 may further include a display device, such as a display screen or touchscreen, and/or an input device, such as a keyboard or mouse, for example (not shown).

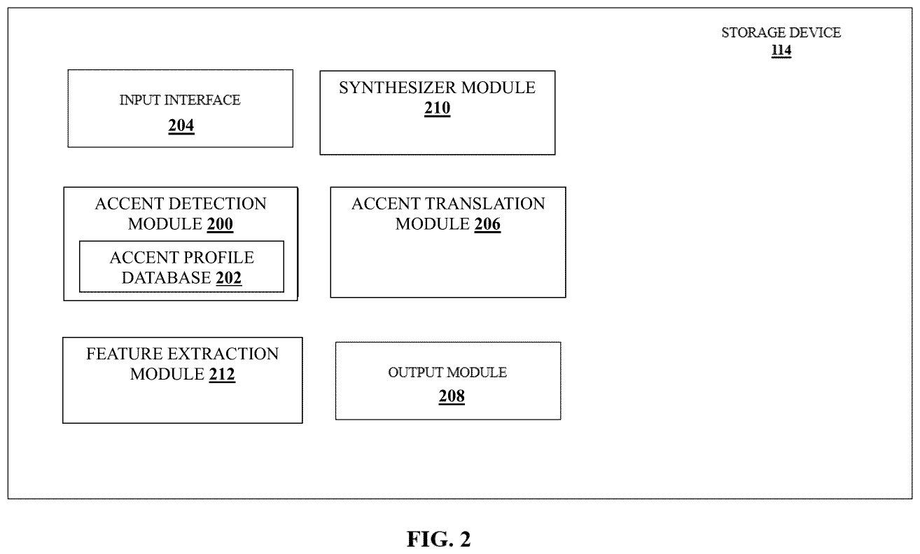

Referring now to FIG. 2, a block diagram of an exemplary one of the storage device(s) 114 of the accent localization device 101 is illustrated. The storage device 114 may include an accent detection module 200 with an accent profile database 202, an input interface 204, an accent translation module 206, an output module 208, a synthesizer module 210, and/or a feature extraction module 212, although other types and/or number of modules can also be used in other examples.

The input interface 204 may serve as an interface through which the accent localization device 101 receives input data and may allow for the input of speech and/or audio data or any other representation that captures characteristics of input speech. The input interface 204 may include various components or functionalities to facilitate the input process and may include hardware components such as microphones or audio interfaces for capturing real-time speech data.

Accordingly, the input interface 204 may facilitate the receipt by the accent localization device 101 of the necessary data to initiate the real-time accent localization process described and illustrated herein. The input interface 204 may be the initial point of interaction between a user (e.g., a user of the first user device 105) or external systems and the accent localization device 101. The input data provided through the input interface 204 may serve as the foundation for subsequent processing and analysis within the accent localization device 101, as described and illustrated in detail below.

The feature extraction module 212 is configured to extract accent features from input speech (e.g., first input speech received from the first user device 105). The accent features in some examples include prosodic characteristics, such as pitch, intonation, and/or rhythm patterns and/or phonetic traits, including specific pronunciations of vowels, consonants, and/or word structures that reveal the first user's accent. In other examples, the accent features can include pitch contours or variation in pitch throughout the speech, intonation patterns including the rise and fall of pitch at the ends of phrases and sentences, and/or phoneme pronunciations or unique production of phonemes in different accents. Additionally, the feature extraction module 212 can be configured to extract linguistic features from input speech.

The accent detection module 200 is configured to determine a geolocation associated with a first user of the first user device 105 in this example. The accent detection module 200 then uses the geolocation to predict a plurality of possible accents for the first user based on a correlation in the accent profile database 202 of geolocations and common accent profiles. The accent detection module 200 then compares the accent features extracted by the feature extraction module 212 with the common accent profiles of the plurality of possible accents to identify a closest matching one of the accent profiles representing the most likely origin of the first user's speech patterns.

The accent translation module 206 is configured to translate linguistic features of the second input speech associated with a second accent of a second user and obtained from the second user device 103. The linguistic features of the second input speech are extracted by the feature extraction module 212 in some examples. The translation of the linguistic features of the second input speech by the accent translation module 206 is based on the closest matching one of the accent profiles detected by the accent detection module 200.

The synthesizer module 210 is configured to combine the accent features extract by the feature extraction module 212 for the second input speech and the translated linguistic features. Thus, the synthesizer module 210 generates a modified version of the second input speech that more closely corresponds to the first accent of the first user and thereby facilitates more effective accent bridging during communication between the first and second users.

The output module 216 optionally facilitates adjustment of speech characteristics, such as speech rate, pitch, or gender, to further customize the representation of the modified version of the second input speech based on user preferences or application requirements, for example. The output module 216 optionally utilizes a vocoder to deliver a seamless and intelligible speech output that reflects the modified version of the second input speech accent localization for the first user's accent. For example, by leveraging the advanced speech techniques described herein, the output module 216 may provide, in real-time or on-demand, a relatively accurate representation of second input speech from a second user in an accent that more closely corresponds to that of a first user.

Although the exemplary network environment with the accent localization device 101, first user device 105, and second user device 103, local network 118, and Internet 120 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as accent localization device 101, first user device 105, and/or second user device 103, for example, may be configured to operate as virtual instances on the same physical machine. In other words, one or more of the accent localization device 101, first user device 105, and/or second user device 103 may operate on the same physical device rather than as separate devices communicating through the local network 118 and/or the Internet 120. Additionally, there may be more or accent localization devices, first user devices, and/or second user devices than illustrated in FIG. 1.

Referring now to FIG. 3, a flow diagram of an exemplary method 300 for real-time accent localization is illustrated. In some examples, the method 300 may be implemented as a software application (e.g., software 116 executed by the central processing unit 102) or a module within a larger system that includes the accent localization device 101 and/or the speech processing system 100. The software application or module may receive input audio data, perform accent localization operations, and provide an output speech in real-time, as explained in detail below.

In step 302 in some examples, the accent localization device 101 of the speech processing system 100 extracts linguistic features from first input speech obtained from Speaker A, which in this example can be a user of the second user device 103. The microphone 128 and the audio interface 126 of the accent localization device 101 can be components of the second user device 103 in this example. In other words, the second user device 103 can be integral with the accent localization device 101. Thus, first input audio data associated with the first input speech can be obtained via the microphone 128.

In step 304, the accent localization device 101 obtains second input speech from Speaker B, which can be another user of the first user device 105 in this example. Accordingly, the second input speech can be associated with second audio data captured at the first user device 105 (e.g., via a microphone and audio interface of the first user device 105). The second input speech can be obtained by the accent localization device 101 via the Internet 120 and/or the local network 118. Thus, the first user device 105 can be remote from the second user device 103 and the accent localization device 101 and the users of the first user device 105 and the second user device 103 can be exchanging communications, such as via voice over Internet protocol (VOIP), for example, although any other method of transmitting input speech can also be used in other examples.

With the obtained second input speech, the accent localization device 101 detects an accent of Speaker B. To detect the accent, the accent localization device 101 determines a geolocation of the first user device 105, extracts accent features from the first input speech, predicts accents of Speaker B based on the geolocation, compares the predicted accents to identify accent profiles, and identifies one of the accent profiles most closely matching the extracted accent features, as explained in more detail below with reference to FIG. 4.

In step 306, the accent localization device 101 translates an accent of the first input speech from Speaker A based on the linguistic features extracted in step 302 and the identified one of the accent profiles most closely matching the accent features extracted from the second input speech of Speaker B. In one example, the translation in step 306 can be performed as described and illustrated in U.S. Pat. No. 11,948,550, which is incorporated by reference herein in its entirety.

In step 308, the accent localization device 101 synthesizes a modified version of the first input speech based on the translated linguistic features. In step 310, the accent localization device 101 uses a vocoder to turn the acoustic features of the modified version of the second input speech into output audio data and associated output speech. The output audio data can then be output, such as via the audio interface 126 and audio output device 130 at the second user device 103.

Thus, the accent of the second input speech from Speaker B in this example is advantageously adjusted based on the accent of the first input speech to facilitate better understanding for the first user and enhanced communication between the first and second users from different linguistic backgrounds, thereby promoting improved collaboration. In other examples, any of steps 302-310 can be performed on any of the first user device 105, second user device 103, and/or accent localization device 101.

Referring now to FIG. 4, a flowchart of an exemplary method 400 for real-time accent localization is illustrated. In some examples, the method 400 may be implemented as a software application (e.g., software 116 executed by the central processing unit 102) or a module within a larger system that includes the accent localization device 101 and/or the speech processing system 100. The software application or module may receive input audio data, perform accent localization operations, and provide an output speech in real-time, as explained in detail below

In step 402 in some examples, the accent localization device 101 of the speech processing system 100 receives first input speech having a first accent from a first user of the first user device 105. The first input speech can be associated with first input audio data captured at the first user device 105 via a microphone and audio interface and the first input speech can be obtained by the accent localization device 101 via the Internet 120 and/or the local network 118, for example.

In step 404, the accent localization device 101 obtains second input speech having a second accent from a second user of the second user device 103. The second input speech can be associated with second input audio data captured at the second user device 103 via another microphone another audio interface and the second input audio speech can be obtained by the accent localization device 101 via the local network 118, for example. In other examples, the accent localization device 101 is integrate with the second user device 103 and the second input speech is captured via the microphone 128 and the audio interface 126. Other permutations of the components illustrated in FIG. 1 can also be used in other examples.

In some examples, this technology facilitates real-time accent bridging during communication, such as between first and second users of the first and second user devices 105 and 103, respectively, that are engaged in a conversation. In these examples, the speech processing system 100 receives input speech (e.g., audio streams representing speech segments) from users. The input speech or audio streams can originate from various communication channels such as phone calls, video conferencing, or online chat platforms, for example.

In step 406, the accent localization device 101 obtains geolocation data to determine a geographic location, also referred to herein as a geolocation, of the first user device 105.

The accent localization device 101 can determine the geolocation of the first user device via various methods, including user-provided information, Internet protocol (IP) address analysis of an IP address associated with the first input speech, and third-party services, for example. In some examples, the first user device 103 is a global positioning system (GPS) enabled mobile device and the accent localization device 101 is configured to pin a GPS transceiver of the first user device 103 to obtain the geolocation data. Other methods for obtaining the geolocation of the first user device 103 can also be used in other examples.

In step 408, the accent localization device 101 determines accent features of the first input speech, which can include pitch, intonation, and/or phoneme pronunciations specific to the first input speech. Thus, in this example, the accent localization device 101 analyzes the first user's first input speech segments to extract accent-specific features such as prosodic characteristics (e.g., pitch, intonation, and rhythm patterns) and/or phonetic traits (e.g., specific pronunciations of vowels, consonants, and/or word structures) that reveal the first accent of the first user. In some examples, the accent features can further include pitch contours including variations in pitch throughout the first input speech, the rise and fall of pitch at the ends of phrases or sentences, and/or a unique production of phonemes. Other types of accent features can also be determined or extracted from the first input speech in other examples.

In step 410, the accent localization device 101 predicts a range of possible accents of the first user based on the geolocation determined in step 406. In some examples, this prediction leverages the accent profile database 202, which links geographic locations with common accent profiles. In some examples, the stored accent profiles represent known regional or language-specific accents, characterized by specific phonetic and prosodic features.

More specifically, in step 412, the accent localization device 101 identifies accent profiles from the accent profile database 202 based on a correlation of those accent profiles with the determined geolocation in the accent profile database 202. The identified, stored accent profiles represent possible accents of the first user.

Then, in step 414, the accent localization device 101 compares the identified accent profiles to the accent features extracted in step 408 to identify one of the identified accent profiles most closely matching the extracted accent features. The identified accent profile represents the most likely origin of the first user's speech patterns.

In step 416, the accent localization device 101 adjusts an accent represented in the second input speech obtained in step 404 based on the identified closest matching one of the accent profiles to generate a modified version of the second input speech. Thus, the speech processing system 100 advantageously modifies the second user's speech in real-time to resemble the identified closest matching accent of the first user.

In step 418, the accent localization device 101 transmits the modified version of the second input speech with the adjusted accent to the first user device 105 in real-time, such as via the local network 118 and the Internet 120, for example. Accordingly, the accent localization device can provide to the audio interface 126 output audio data generated based on the modified version of the second input speech, thereby facilitating effective accent bridging during the communication between the first and second users. One or more of steps 402-418 can be performed in a different order in other examples.

The methods and systems described and illustrated by way of the examples herein have many practical applications including within user devices of employees of multinational corporations to enhance communication between the employees from different linguistic backgrounds and promote better understanding and collaboration. In customer service platforms, this technology can modify the accents of customer service representatives, making their speech more familiar and comprehensible to customers from various regions, thereby improving overall customer satisfaction. Additionally, this technology can be employed in assistive devices for individuals with speech impairments, modifying speech patterns to make their communication clearer to listeners with different accents. The advantages of this technology can be leveraged in many other use cases and types of deployments.

Having thus described the basic concept of the invention, it will be rather apparent to those skilled in the art that the foregoing detailed disclosure is intended to be presented by way of example only and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A speech processing system, comprising a first audio interface coupled to a first microphone, memory having instructions stored thereon, and one or more processors coupled to the memory and the audio interface and configured to execute the instructions to:
in response to first input audio data comprising first input speech obtained from a first user of a first user device, determine a geolocation of the first user device and extract accent features from the first input speech;
compare accent profiles identified based on the determined geolocation to the extracted accent features to identify one of the accent profiles most closely matching the extracted accent features;
adjust an accent represented in second input speech of a second user based on the identified one of the accent profiles to generate a modified version of the second input speech, wherein the second input speech is associated with second input audio data obtained via the first microphone and the first audio interface; and
provide to the first user device for output via an audio output device output audio data generated based on the modified version of the second input speech.

2. The speech processing system of claim 1, wherein the one or more processors are further configured to execute the instructions to identify the accent profiles based on a correlation of the accent profiles with the determined geolocation in an accent profile database, wherein the identified stored accent profiles represent possible accents of the first user.

3. The speech processing system of claim 1, wherein the accent features comprise one or more pitch contours, intonation patterns, or phoneme pronunciations and the pitch contours comprise variations in pitch throughout the first input speech, the intonation patterns comprise the rise and fall of pitch at the ends of phrases or sentences, or the phoneme pronunciations comprise a unique production of phonemes.

4. The speech processing system of claim 1, wherein the accent profiles represent known regional or language-specific accents characterized by phonetic and prosodic features.

5. The speech processing system of claim 1, wherein the one or more processors are further configured to execute the instructions to obtain the first input audio data or the second input audio data from the first user device or a second user device, respectively, via one or more communication networks.

6. The speech processing system of claim 1, wherein the first input audio data is captured via a second microphone coupled to a second audio interface of the first user device and the second audio interface is coupled to the audio output device.

7. A method for real-time accent localization, the method implemented by a speech processing system and comprising:
in response to first input audio data comprising first input speech obtained from a first user device, determining a geolocation of the first user device and extracting accent features from the first input speech;
comparing accent profiles identified based on the geolocation to the accent features to identify one of the accent profiles most closely matching the accent features;
adjusting an accent of second input speech based on the one of the accent profiles, wherein the second input speech is associated with obtained second input audio data; and
providing to the first user device output audio data generated based on the modified version of the second input speech having the adjusted accent.

8. The method of claim 7, further comprising identifying the accent profiles based on a correlation of the accent profiles with the geolocation in an accent profile database, wherein the accent profiles represent possible accents of a first user of the first user device.

9. The method of claim 7, wherein the accent features comprise one or more pitch contours, intonation patterns, or phoneme pronunciations.

10. The method of claim 9, wherein the pitch contours comprise variations in pitch throughout the first input speech, the intonation patterns comprise the rise and fall of pitch at the ends of phrases or sentences, or the phoneme pronunciations comprise a unique production of phonemes.

11. The method of claim 7, wherein the accent profiles represent known regional or language-specific accents characterized by phonetic and prosodic features.

12. The method of claim 7, further comprising obtain the first input audio data or the second input audio data from the first user device or the second user device, respectively, via one or more communication networks.

13. The method of claim 7, further comprising providing the output audio data for output via an audio output device coupled to a first audio interface of the first user device, wherein the second input audio data is captured via a microphone coupled to a second audio interface of the second user device.

14. A non-transitory computer-readable medium comprising instructions that, when executed by at least one processor, cause the at least one processor to:
determine a geolocation of a first user device at which first input audio data comprising first input speech is obtained;
extract accent features from the first input speech;
identify accent profiles based on the geolocation;
compare the accent profiles to the accent features to identify one of the accent profiles most closely matching the accent features;
generate a modified version of second input speech to adjust an accent based on the one of the accent profiles; and
provide to a first audio interface of the first user device output audio data generated based on the modified version of the second input speech.

15. The non-transitory computer-readable medium of claim 14, wherein the instructions, when executed by the at least one processor further cause the at least one processor to identify the accent profiles based on a correlation of the accent profiles with the geolocation in an accent profile database, wherein the accent profiles represent possible accents of a first user of the first user device.

16. The non-transitory computer-readable medium of claim 14, wherein the accent features comprise one or more pitch contours, intonation patterns, or phoneme pronunciations.

17. The non-transitory computer-readable medium of claim 16, wherein the pitch contours comprise variations in pitch throughout the first input speech, the intonation patterns comprise the rise and fall of pitch at the ends of phrases or sentences, or the phoneme pronunciations comprise a unique production of phonemes.

18. The non-transitory computer-readable medium of claim 14, wherein the accent profiles represent known regional or language-specific accents characterized by phonetic and prosodic features.

19. The non-transitory computer-readable medium of claim 14, wherein the instructions, when executed by the at least one processor further cause the at least one processor to obtain the first input audio data or the second input audio data from the first user device or the second user device, respectively, via one or more communication networks and the second input audio data is associated with the second input speech.

20. The non-transitory computer-readable medium of claim 14, wherein the instructions, when executed by the at least one processor further cause the at least one processor to provide the output audio data for output via an audio output device coupled to the first audio interface of the first user device, wherein second input audio data associated with the second input speech is captured via a microphone coupled to a second audio interface of the second user device.
